(19) United States
(12) Patent Application Publication
(10) Pub. No.: US 2014/0139167 A1
(43) Pub. Date: May 22, 2014

(54) TRANSFORMERLESS MULTILEVEL CONVERTER

(71) Applicant: ABB Technology AG, Zurich (CH)

(72) Inventor: Peter STEIMER, Ehrendingen (CH)

(73) Assignee: ABB Technology AG, Surich (CH)

(21) Appl. No.: 14/164,981

(22) Filed: Jan. 27, 2014

Related U.S. Application Data
(63) Continuation of application No. PCT/EP2012/062828, filed on Jul. 2, 2012.

(30) Foreign Application Priority Data
Aug. 4, 2011 (EP) 11176607.7

(51) Int. Cl. H02P 27/16; H02M 5/297; H02P 27/06

(52) U.S. Cl. CPC H02P 27/16; H02P 27/06; H02M 5/297
USPC 318/494; 363/43

(57) ABSTRACT

An exemplary medium voltage system includes a multilevel converter connected to a grid connection. The multilevel converter is configured for converting a first multiphase current provided at the grid connection into a second current. The system includes a common mode filter, which, for each phase of the first current, includes a phase filter connected to the respective phase. Each phase filter is connected to a common filter star point which is connected to ground, includes an inductance and a capacitance connected in series, and includes a resistance connected in series with the capacitance such that the inductance and the resistor are connected in parallel. The common mode filter includes an impedance between the common filter star point and the ground.

### RELATED APPLICATION(S)

This application claims priority under 35 U.S.C. §120 to International application PCT/EP2012/062828 filed on Jul. 2, 2012, designating the U.S., and claiming priority to European application EP 11176607.7 filed in Europe on Aug. 4, 2011. The content of each prior application is hereby incorporated by reference in its entirety.

### FIELD

The disclosure relates to the field of power electronics circuits, and particularly to a medium voltage system with a multilevel converter.

### BACKGROUND INFORMATION

Known medium voltage systems with a multilevel converter can be used for converting a first current from a power grid into a second current that can be supplied to a further grid or an electrical motor, or can be supplied from a generator into the power grid.

Many of the known medium voltage systems can be designed to include an isolation transformer, which often has a very low efficiency (e.g., as low as 97% at 1 MVA) due to cost and size specifications.

U.S. Pat. No. 5,625,545 describes a medium voltage system as such, where a low efficiency isolation transformer is realized if the grid voltage matches a voltage to be supplied to an electrical motor.

In transformerless medium voltage systems, the available common mode impedance characteristic of an isolation transformer can be replaced by common mode impedances. This design is described, for example in “An Integrated DC Link Choke for Elimination of Motor Common mode Voltage in Medium Voltage Drives” Bin Wu, S. Rizzo, N. Zargari and Y. Xiao, IAS 2001 and “Medium voltage AC drive, ACS 2000”, ABB Product Brochure, 2010.

### SUMMARY

An exemplary medium voltage system is disclosed, comprising: a multilevel converter connected to a grid connection, wherein the multilevel converter is configured for converting a first multiphase current provided at the grid connection into a second current; and a common mode filter, which, for each phase of the first current, includes a phase filter connected to the respective phase, wherein each phase filter is connected to a common filter star point which is connected to ground, and includes an inductance and a capacitance connected in series, and a resistance connected in series with the capacitance such that the inductance and the resistor are connected in parallel, and wherein the common mode filter includes an impedance between the common filter star point and the ground.

### BRIEF DESCRIPTION OF THE DRAWINGS

The subject-matter of the disclosure will be explained in more detail in the following text with reference to exemplary embodiments which can be illustrated in the attached drawings.

FIG. 1 shows a circuit diagram with low impedance grounding in a grid in accordance with an exemplary embodiment of the present disclosure;

FIG. 2 shows a circuit diagram with high resistance grounding in a grid in accordance with an exemplary embodiment of the present disclosure;

FIG. 3 shows a schematic diagram of a first medium voltage system in accordance with an exemplary embodiment of the present disclosure;

FIG. 4 shows a schematic diagram of a second medium voltage system in accordance with an exemplary embodiment of the present disclosure;

FIG. 5 shows a schematic diagram of a third medium voltage system in accordance with an exemplary embodiment of the present disclosure;

FIG. 6 shows a schematic diagram of a fourth medium voltage system in accordance with an exemplary embodiment of the present disclosure;

FIG. 7 shows a schematic diagram of a fifth medium voltage system in accordance with an exemplary embodiment of the present disclosure;

FIG. 8 shows a schematic diagram of a sixth medium voltage system in accordance with an exemplary embodiment of the present disclosure;

FIG. 9 shows a schematic diagram of a seventh medium voltage system in accordance with an exemplary embodiment of the present disclosure;

FIG. 10 shows a schematic diagram of an eighth medium voltage system in accordance with an exemplary embodiment of the present disclosure;

FIG. 11 shows a schematic diagram of a ninth medium voltage system in accordance with an exemplary embodiment of the present disclosure;

FIG. 12 shows a common mode equivalent circuit of a medium voltage system in accordance with an exemplary embodiment of the present disclosure;

FIG. 13 shows a circuit diagram for a cable model that can be used for a simulating medium voltage system in accordance with an exemplary embodiment of the present disclosure;

FIG. 14 shows a circuit diagram for a model of an electrical machine that can be used for a simulating medium voltage system in accordance with an exemplary embodiment of the present disclosure;

FIG. 15 shows a circuit diagram for an ANPCML inverter for a medium voltage system in accordance with an exemplary embodiment of the present disclosure;

FIG. 16 shows a circuit diagram for an indirect MMLC inverter for a medium voltage system in accordance with an exemplary embodiment of the present disclosure;

FIG. 17 shows a circuit diagram for a direct MMLC converter for a medium voltage system in accordance with an exemplary embodiment of the present disclosure;

FIG. 18 shows a schematic diagram of a tenth medium voltage system in accordance with an exemplary embodiment of the present disclosure;

FIG. 19 shows a schematic diagram of an eleventh medium voltage system in accordance with an exemplary embodiment of the present disclosure;

FIG. 20 shows a schematic diagram of a twelfth medium voltage system in accordance with an exemplary embodiment of the present disclosure;

FIG. 21 shows a diagram with a common mode voltage at the grid side of a low impedance grounded system in accordance with an exemplary embodiment of the present disclosure;

FIG. 22 shows a diagram with a common mode voltage at the grid side of a high impedance grounded system in accordance with an exemplary embodiment of the present disclosure;

FIG. 23 shows a diagram with a common mode voltage at the PCC of a system in accordance with an exemplary embodiment of the present disclosure; and

FIG. 24 shows a diagram with a common mode voltage at the machine star point of a system in accordance with an exemplary embodiment of the present disclosure.

### DETAILED DESCRIPTION

Exemplary embodiments of the present disclosure provide common mode grounding for a transformerless medium voltage system with a multilevel converter.

Exemplary embodiments of the present disclosure relate to a medium voltage system. It should be understood that a medium voltage system can be an electrical system that is adapted to process voltages above 1 kV and/or below 50 kV, for example below 15 kV.

According to an exemplary embodiment of the disclosure, the medium voltage system includes a multilevel converter connected to a grid connection, wherein the multilevel converter can be configured for converting a first multiphase current provided at the grid connection into a second current, and a common mode filter, which, for each phase of the first current, includes a phase filter connected to the respective phase. The phase filters of the common mode filter can be connected to a common filter star point which is connected to ground. Each phase filter includes a capacitance, e.g., at least one capacitor. The medium voltage system can be connected to ground at the grid side via the common filter star point.

A multilevel converter can be an electrical converter that is configured to generate more than two or three output voltage levels, for example 5, 7, or more voltage output levels. In other words, the second current can have more than three output voltage levels.

The first multiphase current can be an AC current with more than two phases. For example, the first multiphase current can have two or three phases.

The multilevel converter can be directly connected to the grid connection, for example without a transformer. The multilevel system can be transformerless on the grid side.

The grid connection can be the point of common coupling (PCC), which can be defined as point where the medium voltage system as local electric power system is connected to a large (non-local) power grid.

With the common mode filter, in a transformerless medium voltage system, common mode inductance can be avoided. By introducing a small capacitive common mode filter on the grid side of the medium voltage system with a low impedance ground connection at the star point, a common mode voltage capacitive coupling to ground can be achieved. As a result, no significant common mode voltages or currents can reach the grid in low and high impedance grounded systems.

When the medium voltage system includes an electrical machine supplied with the second current, the additional common mode stress on the medium voltage machine windings and related bearing current effects can be well under control even for standard electrical machines and retrofit applications.

The solution can be applied to any multilevel converter with any multilevel topology (VSI with 7 levels and higher) by common mode grounding the system close to the PCC (point of common coupling). Common mode impedances can be eliminated without endangering the winding insulation or the bearing lifetime of the electrical machine or the specifications of the grid connection.

In a two- or three-phase system, the common mode filter, which can provide a low impedance grounding, can include a rather small two-phase or three-phase capacitive filter on the grid side. The capacitive filter can include two or three capacitors with equal capacity connected at the star point.

The common mode filter can have a capacity which is about 10 times bigger than any machine side capacitive ground impedance, which can be a machine side filter, a machine side cable, or the machine winding capacitance to ground.

Furthermore, the small capacitive common mode filter on the grid side can be a tuned filter and can comprise further inductivities and/or resistors.

According to an exemplary embodiment of the disclosure, each phase filter includes an inductance (e.g., inductor) connected in series with the capacitance (e.g., capacitor) and/or a resistance (e.g., resistor) connected in series with the capacitance. The inductance and the resistance can be connected in parallel. Such a tuned filter design can have the additional advantage that a resulting differential mode resonance on the grid side can be less variable, which can facilitate the robust realization of the active damping of grid-side resonances or harmonic rejection by the converter.

According to another exemplary embodiment of the disclosure, the common mode filter includes an impedance between the filter star point and the ground. The solid connection of the filter star point or common point to ground can include some additional impedance. This impedance can be of a resistive, capacitive, or inductive type and/or can include capacitors, inductors, and resistors in series or in parallel. Additional impedance, as described, can offer some additional benefits in regards of lower ground currents or ground fault selectivity, such as for parallel connected systems.

In accordance with an exemplary embodiment of the disclosure, the common mode filter, for each phase, includes an inductance connected between the grid connection and the multilevel converter. The common mode filter can be combined with other filters on the grid side that are not grounded.

According to yet another an exemplary embodiment of the disclosure, a connection point of a phase filter to the respective phase is between the grid connection and the inductance between the grid connection and the multilevel converter. These additional filters can be between the basic common mode filter and the multilevel converter. The connection of the common mode filter can be directly at the grid connection and/or can be near the point of common connection (PCC).

The common mode filter can be applied to transformerless medium voltage drives, transformerless wind power system, transformerless solar systems and/or transformerless interties.

According to an exemplary embodiment disclosed herein, the medium voltage system includes an electrical motor for receiving the second current. The medium voltage system can be a medium voltage drive.

According to an exemplary embodiment of the disclosure, the medium voltage system includes an electrical generator for generating the second current. For example, the medium voltage system can be part of a tidal power station or a wind power station.

Still in another exemplary embodiment of the disclosure, the medium voltage system includes a DC source for providing the second current. For example, the DC source can be a DC link or at least one solar panel. The medium voltage system can be a solar power station.

Another exemplary embodiment of the disclosure provides that the medium voltage system include a transformer for transforming the second current. It shall be understood that the medium voltage system can be transformerless at the grid side. While on the machine side, the medium voltage system can include one or more transformers between the multilevel converter and the electrical machine or generator connected to the second current.

The medium voltage system can include any kind of VSI based multilevel converter, such as for example for an ANPCML converter, a direct and indirect MMLC converter, such as chain link type STATCOMs (with full bridges).

According to an exemplary embodiment of the disclosure, the multilevel converter is an ANPCML (active neutral point clamped multi-level) converter.

In an exemplary embodiment described herein, the multilevel converter is an indirect MMLC (modular multilevel) converter. The common mode filter can be used with two quadrant (2Q) or with four quadrant (4Q) medium voltage power conversion, e.g., with a multilevel converter including a rectifier and an inverter, wherein the inverter and optionally the rectifier includes power modules of an MMLC converter. However, the rectifier can be a passive rectifier or diode frontend.

According to an exemplary embodiment of the disclosure, the multilevel converter can include a direct MMLC converter.

These and other aspects of the disclosure will be apparent from and elucidated with reference to the exemplary embodiments described hereinafter.

In principle, identical parts are provided with the same reference symbols in the figures.

### Grounding Concepts in Medium Voltage Grids

For example, to reduce transient over-voltages, either solid or impedance grounding is used. A grounded system can have the further advantage that ground fault localization is possible.

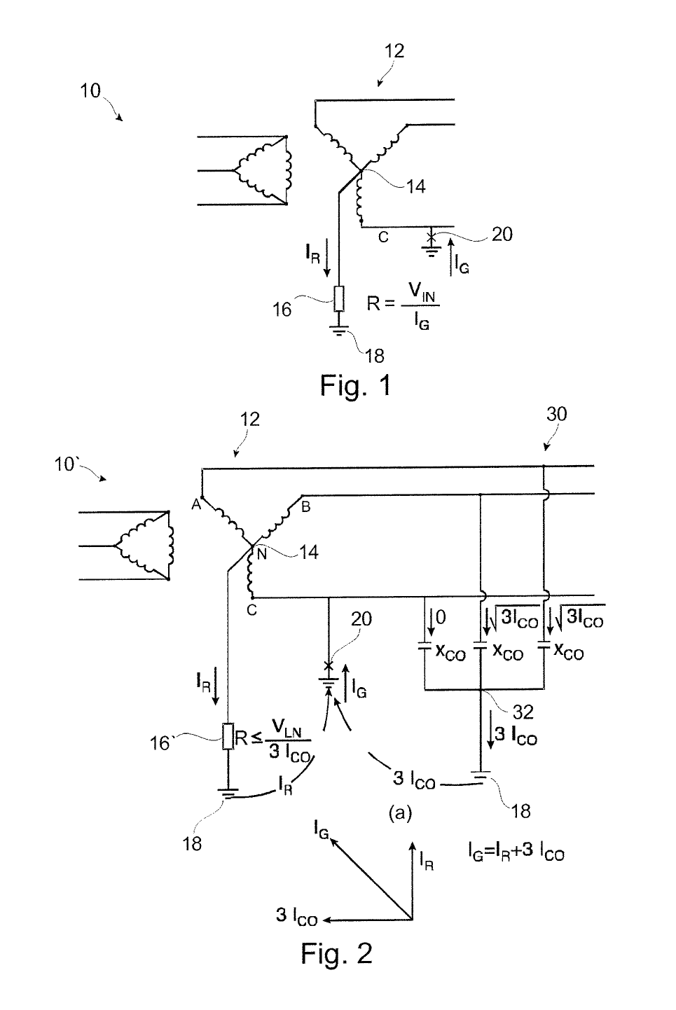

FIG. 1 shows a circuit diagram with low impedance grounding in a grid in accordance with an exemplary embodiment of the present disclosure. The system 10 includes a transformer 12, which has windings interconnected in a star point 14. The star point 14 is connected via a low impedance 16 to the ground 18. In the case of a ground fault 20, a grounding current I_{G} can be equalized via the low impedance 16.

FIG. 2 shows a circuit diagram with high resistance (e.g., high impedance) grounding in a grid in accordance with an exemplary embodiment of the present disclosure. In the system 10′, the star point 14 of the transformer 12 can be connected via high impedance 16′ to the ground 18.

The system 10′ further includes a common mode filter 30 with three capacitors X_{CO} interconnected by a common filter star point 32. A common mode current I_{CO}, generated by an earth fault 20 can be equalized by the common mode filter 30.

The resistor 16′ is selected such that the current I_{R} through the resistor, the grounding current I_{G} and the common mode current I_{CO} cancel each other.

In the context of the present disclosure, the following impedance grounding concepts can be used in medium voltage distribution grids up to 15 kV, for example, low impedance grounding (e.g., to limit ground fault current I_{G} between 100 A to 1000 A or suitable current range as desired), high impedance grounding (e.g., to limit the resistor current I_{R} to 10 A or less or other suitable current range as desired), reactance grounding (e.g., if the desired current magnitude is several thousand amperes), and resonant grounding (e.g., ground fault neutralizer).

In the following, for the transformerless medium voltage systems shown in the following figures, low and high impedance grounding is investigated, as they can be seen as the two extremes in regards of the grounding impedance.

Medium Voltage Systems with Multilevel Converter

Exemplary Figures of the present disclosure show medium voltage systems 40 with a multilevel converter 42 that all comprise a common mode filter 30.

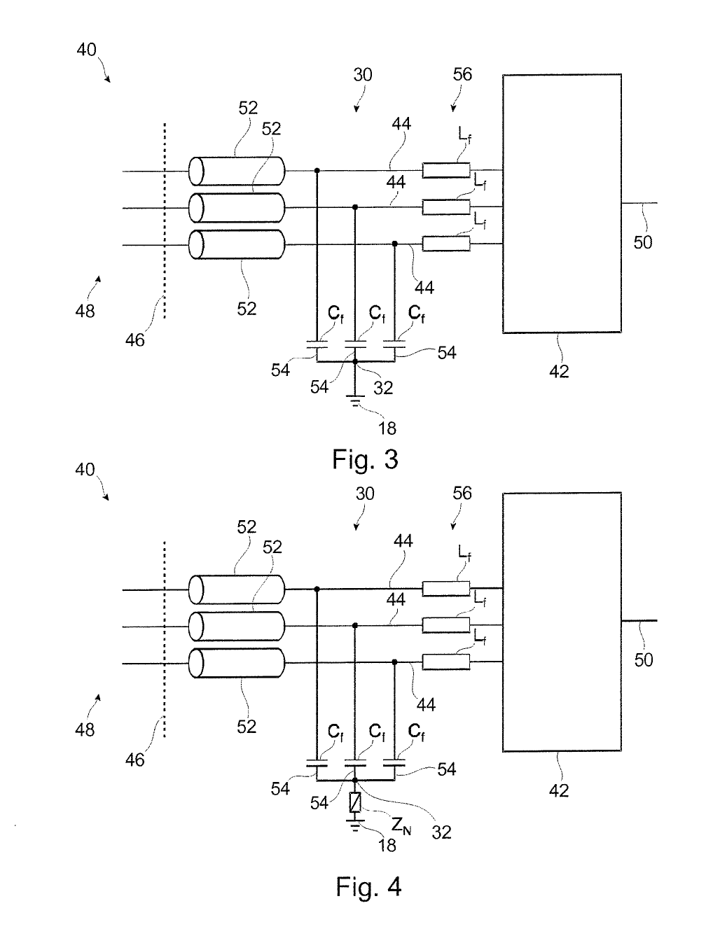

FIG. 3 shows a schematic diagram of a first medium voltage system in accordance with an exemplary embodiment of the present disclosure. As shown in FIG. 3, the system 40 includes a multilevel converter 42 that is connected via three phases 44 to a grid connection 46. The grid connection 46 can be the point of common coupling interconnecting the medium voltage system 40 with an electrical grid 48.

The multilevel converter 42 can be configured to convert a first multiphase current in the phases 44 into a second current to be supplied to a further electrical connection 50.

At the grid side, the system 40 includes a common mode filter 30, which includes three capacitors C_{f} that, at one end, are connected to a respective phase 44 and, at another end, are commonly connected to a star point 32. In accordance with an exemplary embodiment, the star point 32 of the system 40 is grounded. Each capacitor C_{f} can be seen as a phase filter 54 for the respective phase 52.

The system 40 can be connected to the grid connection 46 by a set of medium voltage cables 52. The filter 30 can be connected to the phases 44 after the cables 52. Furthermore, the system 40 can include a further grid side filter 56, which includes an inductance L_{f} for each phase 44 and which is interconnected between the common mode filter 30 and the multilevel converter 42. The inductance L_{f} can be seen as a part of the respective phase filter 54.

FIG. 4 shows a schematic diagram of a second medium voltage system in accordance with an exemplary embodiment of the present disclosure. As shown in FIG. 4, the common mode filter 30 can further comprise an impedance Z_{N} connected between the star point 32 and the ground 18.

In this case, the solid connection of the filter star point 32 or common point 32 to ground 18 can include some additional impedance Z_{N}. This impedance Z_{N} can be of resistive, capacitive, or inductive type or combinations of multiple such elements in series or in parallel.

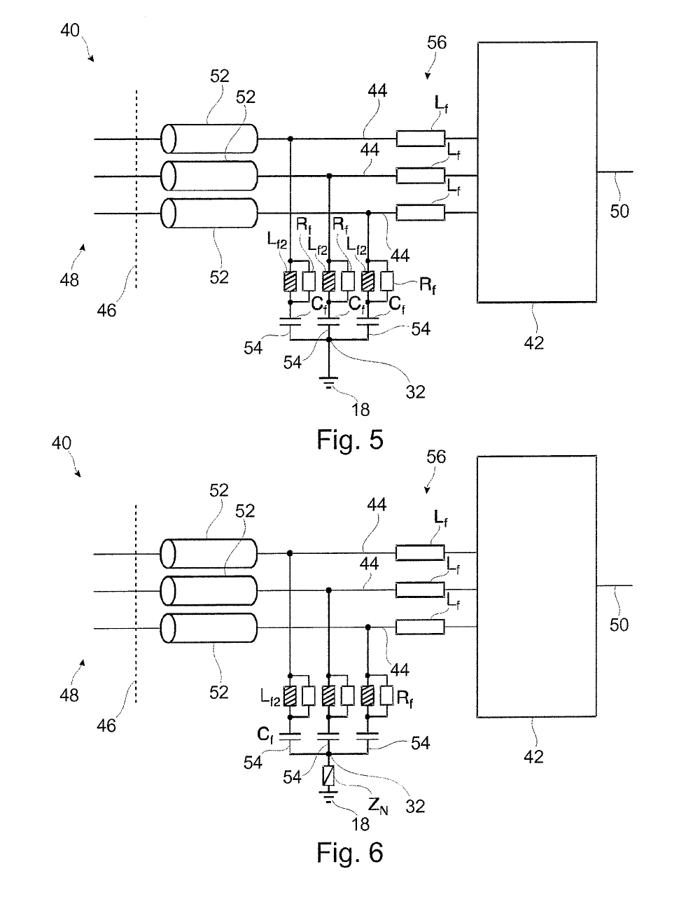

FIG. 5 shows a schematic diagram of a third medium voltage system in accordance with an exemplary embodiment of the present disclosure. As shown in FIG. 5, the common mode filter 30 can be a tuned filter 30 at the grid side. Each phase filter 54 of the common mode filter 30 includes an inductance L_{f2} and a resistor R_{f} connected in parallel, which are connected in series with the capacitor C_{f}.

The small capacitive common mode filter 30 can be tuned to keep the resulting differential mode resonance on the grid side less variable and to facilitate the robust realization of the active damping of grid side resonances or harmonic rejection by the converter 42.

FIG. 6 shows a schematic diagram of a fourth medium voltage system in accordance with an exemplary embodiment of the present disclosure. As shown in FIG. 6, a tuned common mode filter 30 can be combined with the impedance Z_{N} in the ground connection.

The common mode filter 30 can be applied to transformerless power electronics systems, like transformerless grid couplings or transformerless grid interfaces for renewable energy sources.

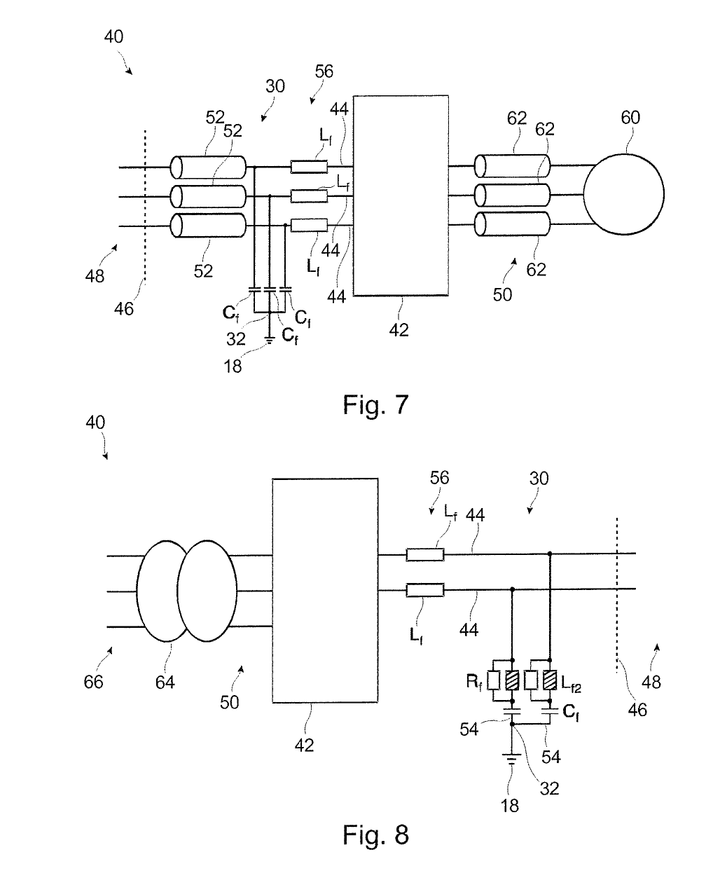

FIG. 7 shows a schematic diagram of a fifth medium voltage system in accordance with an exemplary embodiment of the present disclosure. As shown in FIG. 7, the system 40 can include an electrical motor 60 that is connected via the second connection 50 to the multilevel converter 42. The second connection 50 can be a multiphase connection (in the present case a three-phase connection) also including a set of medium voltage cables 62.

FIG. 8 shows a schematic diagram of a sixth medium voltage system in accordance with an exemplary embodiment of the present disclosure. As shown in FIG. 8, the system 40 can comprise a transformer 64 that is connected via the second connection 50 to the multilevel converter 42. For example, the system 40 can be an interface between an electrical grid 48 and an electrical grid 66.

FIG. 8 further shows that the connection between the grid 48 and the multilevel converter 42 can be a two-phase connection. In an exemplary embodiment, the common mode filter 30 can include up to two-phase filters 54.

The system 40 of FIG. 8 can be seen as a transformerless grid coupling from three-phase to one- or two-phase. It should be understood that according to another exemplary embodiment, the system 40 can be transformerless on the side with the common mode filter 30.

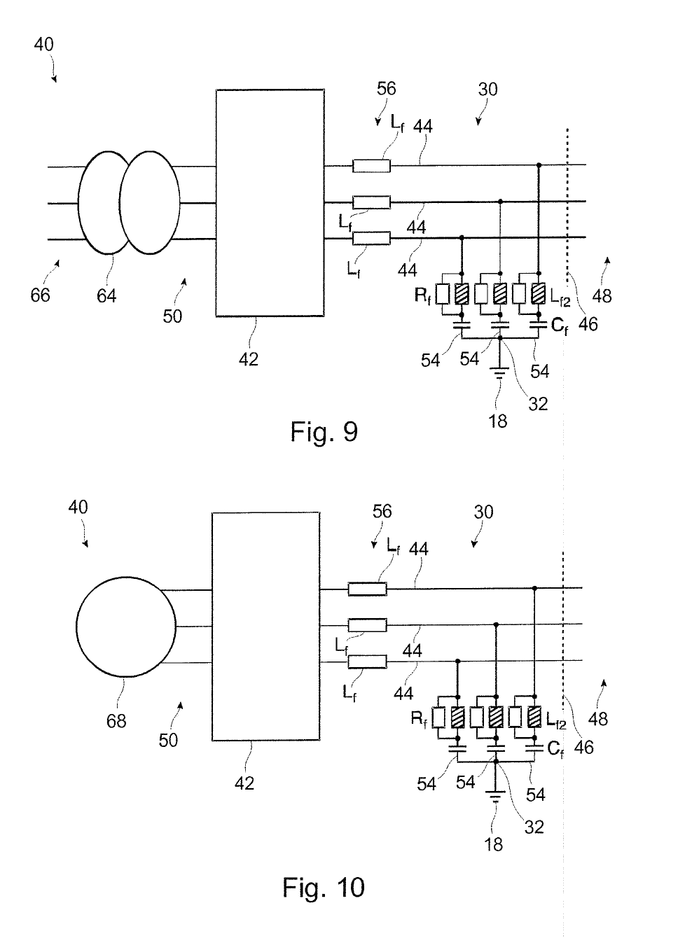

FIG. 9 shows a schematic diagram of a seventh medium voltage system in accordance with an exemplary embodiment of the present disclosure. As shown in FIG. 9, the system 40 that can configured as a transformerless grid coupling from three-phase to three-phase.

FIG. 10 shows a schematic diagram of an eighth medium voltage system in accordance with an exemplary embodiment of the present disclosure. As shown in FIG. 10, the system 40 can include a (rotating) electrical generator 68. For example, the generator 40 can be connected to a turbine of a water or tidal power station or to a wind turbine.

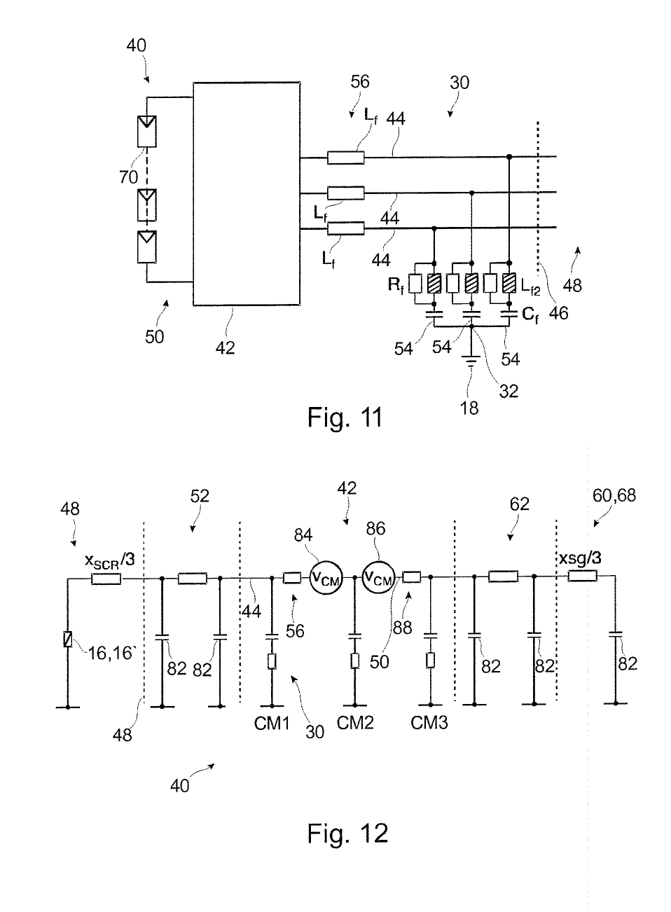

FIG. 11 shows a schematic diagram of a ninth medium voltage system in accordance with an exemplary embodiment of the present disclosure. As shown in FIG. 11, the system 40, in which the multilevel converter 50 is connected to solar panels 70. The connection 50 can be a DC current connection.

### Grounding of a Transformerless Medium Voltage Drive

FIG. 12 shows a common mode equivalent circuit of a medium voltage system in accordance with an exemplary embodiment of the present disclosure. In regards of common mode effects, the grounding concept of the medium voltage system 40 is of central interest. For the relevant common mode investigations of the medium voltage system 40, the corresponding common mode equivalent circuit as shown in FIG. 12 can be used.

The neutral grounding resistance 16, 16′ of the feeding medium voltage grid 48 and the capacitive impedances 82 can be of importance, which are pulling the main circuits closer to ground (e.g., high frequency equivalents). Capacitive impedances 82 of relevance can be those of power cables 52, 62 and machine windings of the electrical machine 60, 68.

FIG. 12 further shows a grid side filter 56 and a machine side filter 88, which can be a dv/dt filter.

In accordance with an exemplary embodiment of the present disclosure, it can be assumed that other differential mode harmonic specifications are met by the multilevel converter 42.

As shown in FIG. 12, there are three possibilities to ground a medium voltage system 40, on the grid side (CM1), on the neutral-point of the converter (CM2), or on the machine side CM3).

In known implementations, the CM2 grounding in the DC link of the power conversion system has been utilized, as the common mode equivalent voltage sources of the AC to DC power conversion (rectifier) stage 84 or DC to AC power conversion (inverter) stage 86 are separated, and any movement to ground is limited to the amplitude of one equivalent common mode voltage source (and not the sum of it). The CM3 grounding has been utilized in cases, where the main objective has been to keep any common mode voltage movement away from the electrical machine 60, 68.

For the realization of a transformerless medium voltage drive system 40, it should be understood that known techniques of electrical coupling to a grid 48 are changing fundamentally. For example, an isolation transformer, which has high common mode impedance to the grid 48, is being used less often. The common mode stresses (voltage, currents) that are applied by the converter 42 to the grid 48 are getting more important.

These circumstances can be resolved by grounding at CM3 or CM2 and by using an additional common mode impedance between the converter 42 and the grid 48, to limit the amount of common mode voltages and/or current, reaching the medium voltage grid.

However, with the medium voltage system 40 shown in FIGS. 3 to 11, CM1 is used as the grounding point. This can efficiently limit any common mode voltage or current stress reaching the grid 48. Additionally, these new concepts avoid the generation of common mode reactance, which can be an advantage with respect to costs and size.

Large machine winding capacitances 82, machine side cable capacitances 82, and machine side (dv/dt) filters 88 can establish common mode capacitive impedances to ground. They can therefore ground the common voltage system, such as for higher frequencies, at the machine side. In such a case all, the common mode voltages (and thereby generated common mode currents) would appear at the grid side.

This circumstance can be avoided by having common mode capacitive impedance 30 to ground 18 at the grid side, at CM1. With this measure, the common mode stress can be shifted to the machine side, which can limit the common mode stress on the grid side. This additional machine side common mode stress is acceptable, even for standard electrical machines 60, 68 including retrofit applications.

By grounding the medium voltage system 40 at CM1, the generation of additional common mode impedances can be avoided. As explained with respect to FIGS. 3 to 11, the (low impedance) grounding can be done on the grid side at the star point 32 of a small three-phase capacitive filter C_{f}. This three-phase capacitive filter 30 creates a common mode impedance to ground of 3×C_{f}.

The installed grid-side common mode capacitance (=3×C_{f}), which can include the grid-side cable capacitances 82 to ground 18, can be substantially larger than the machine side capacitances 82 to ground, which can include capacitances of windings of the machine 60, 86, of cables 62 and/or of dv/dt filters 88. This can allow achieving common mode grounding on the grid side, which helps to keep common mode harmonic distortion away from the grid 48.

### Medium Voltage Cables

For the investigation of the medium voltage system 40 it is beneficial to know the data of medium voltage cables 52, 62, as they can introduce considerable capacitance and additional resonance frequencies. A higher voltage design can be chosen to represent the worst case of the influence of the cables 52, 62. On the other side, the lengths of the cables 52, 62 can be limited to 200 m on both sides of the multilevel converter 42. Longer cables 52, 62 can be possible.

The following table shows medium voltage data for a 12/20 kV XPLE cable:

Cable data (Copper)-XLPE-12/20 kV-1 or 3 wire

| | | |
|---|---|---|
| Area | 50 | [mm²] |
| Rating | 220 | [A] |
| Resistance | 0.387 | [Ω/km] |
| DC@20° C. | | |
| Resistance | 0.493 | [Ω/km] |
| DC@90° C. | | |
| Capacitance | 0.17 | [μF/km] |
| Inductance | 0.44 | [mH/km] |

For a 200 m cable (for a 200 A current rating) the following values per single phase cable can be observed:

R_cable=100 mOhm=0.5 Ohm/5

L_cable=87 μH=0.44 mH/5

C_cable=34 nF=0.17 μH/5

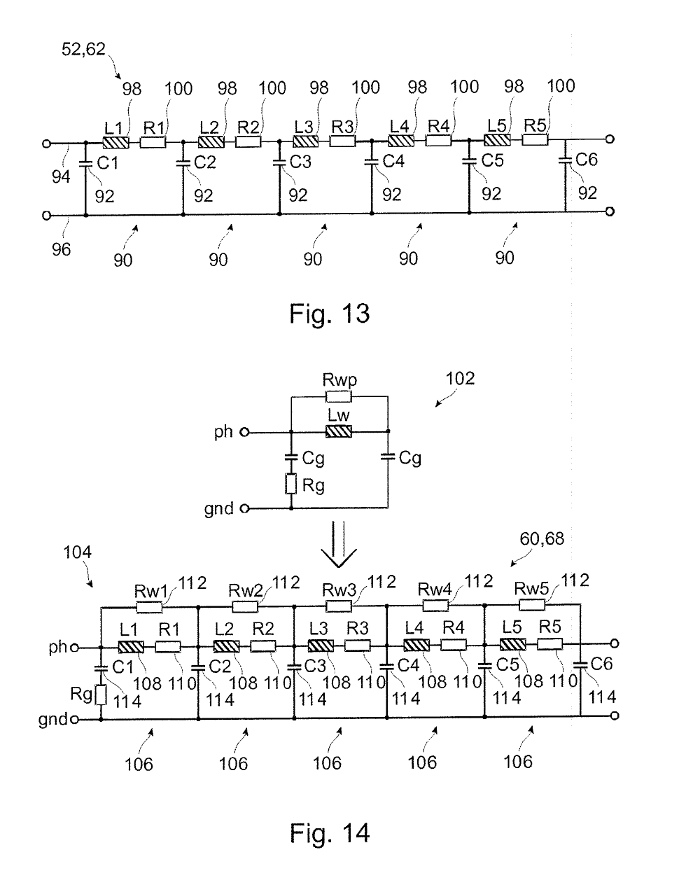

FIG. 13 shows a circuit diagram for a cable model that can be used for a simulating medium voltage system in accordance with an exemplary embodiment of the present disclosure. In particular, FIG. 13 shows a circuit diagram for a one phase equivalent cable model that can be used for medium voltage cable simulation. The cable 52, 62 includes a plurality of sections 90 that are connected in series. Each section includes a capacitor 92, interconnecting two lines 94, 96 of the cables 52, 62 and an inductance 98 connected in series with a resistor 100 in one of the lines 94.

### Medium Voltage Machine

As an example, the data of two medium voltage electrical machines 60, 68 is given in the following. The shown winding capacitance is the total value given for all three phases of an electrical AC machine 60, 68.

The following table shows data for a 2 MVA, 6 pole, 50 Hz electrical machine 60, 68.

| | | |
|---|---|---|
| VLL | 6600 | [V] |
| V_phase | 3811 | [V] |
| IL | 175 | [A] |
| S | 2000 | [kVA] |
| L_stray | 10.40 | [mH] |
| Cwind_tot | 0.15 | [μF] |
| fres | 7103 | [Hz] |

The following table shows data for a 4.75 MVA, 6 pole, 50 Hz electrical machine 60, 68.

| | | |
|---|---|---|
| VLL | 6600 | [V] |
| V_phase | 3811 | [V] |
| IL | 416 | [A] |
| S | 4750 | [kVA] |
| L_stray | 4.38 | [mH] |
| Cwind_tot | 0.25 | [μF] |
| fres | 8269 | Hz] |

Of special interest is the resulting resonance frequency fres (which is the machine winding resonance) in the electrical machine 60, 68 given by the machine internal stray impedances L_stray (for high frequencies) and the winding capacitance Cwind_tot.

FIG. 14 shows a circuit diagram for a model of an electrical machine that can be used for a simulating medium voltage system in accordance with an exemplary embodiment of the present disclosure. In particular, FIG. 14 shows a simplified high frequency model of the electrical machine 60, 68 that has been derived from the data of the above tables. The stray impedance L_stray and the total winding capacitance Cwind_tot are distributed within the high frequency model, which can be similar to the cable model shown in FIG. 13.

A simple model 102 of the windings of the electrical machine 60, 68, which are interconnecting a phase ph with a grounding point gnd, include a resistance Rwp and an inductance Lw connected in parallel. At each end, the resistance Rwp and an inductance Lw are connected via a capacity Cg to the grounding point Cg. At one end, the connection is established via a grounding resistance Rg.

From the simple model 102, a circuit model 104 for simulation is derived which is shown below the simple model. The circuit model 104 includes a plurality of sections 106 that are connected in series. Each section 106 includes an inductance 108 connected in series with a first resistor 110, which are both connected in parallel with a second resistor 112. Each section 106 includes a capacitor 114 interconnecting the components 108, 110, 112 with the grounding point gnd.

### Medium Voltage Multilevel Converter

For the medium voltage power conversion, several multilevel topologies for the converter 42 can be used.

The following examples are shown as five-level converters 42, but all of them can be expanded to a higher number of levels.

As indicated in FIG. 12, the converter 42 can include an inverter 86 that can be combined with a rectifier 84 for a back to back AC/DC/AC system, which can be used for a multilevel converter 42 for a transformerless medium voltage drive system 40.

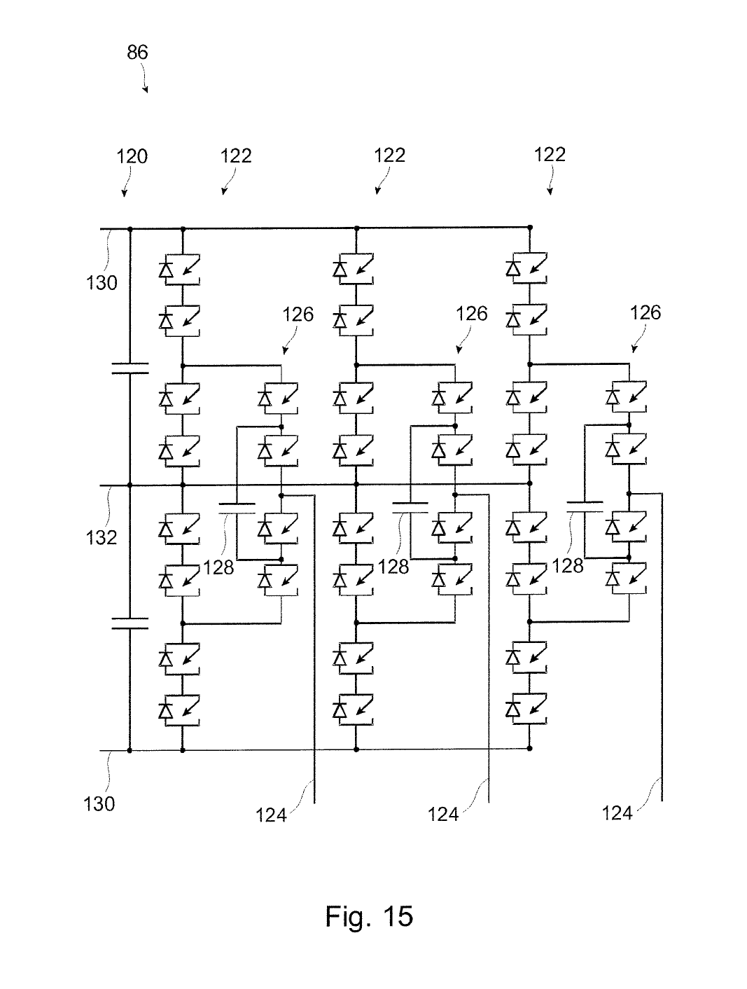

FIG. 15 shows a circuit diagram for an ANPCML inverter for a medium voltage system in accordance with an exemplary embodiment of the present disclosure. As shown in FIG. 15, an ANPCML (active neutral point clamped multilevel) inverter 86 includes a DC link 120 and three phase branches 122 that are adapted to generated a five-level output voltage at the respective phase output 124. Each phase branch 124 includes inverter cells 126 that can include an internal capacitor 128, e.g., a capacitor 128 that is not directly connected to the DC link inputs 130 or the neutral point 132.

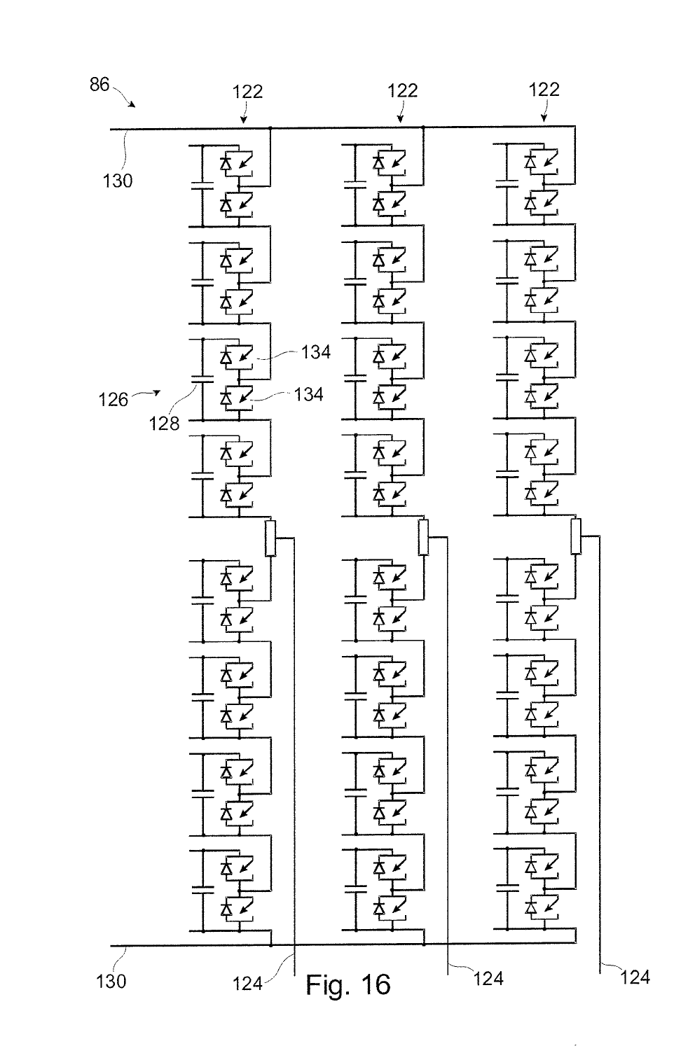

FIG. 16 shows a circuit diagram for an indirect MMLC inverter for a medium voltage system in accordance with an exemplary embodiment of the present disclosure. As shown in FIG. 16, an MMLC (modular multilevel) inverter 86 includes three multilevel phase branches 122 that are configured to generated a five-level output voltage at the respective phase output 124. Each branch includes a plurality of inverter cells 126 that are connected in series. Each inverter cell 126 includes an internal capacitor 128 that is connected in parallel to two semiconductor switches 134.

The MMLC inverter 86 can be combined with a rectifier 84 to an indirect MMLC converter 42.

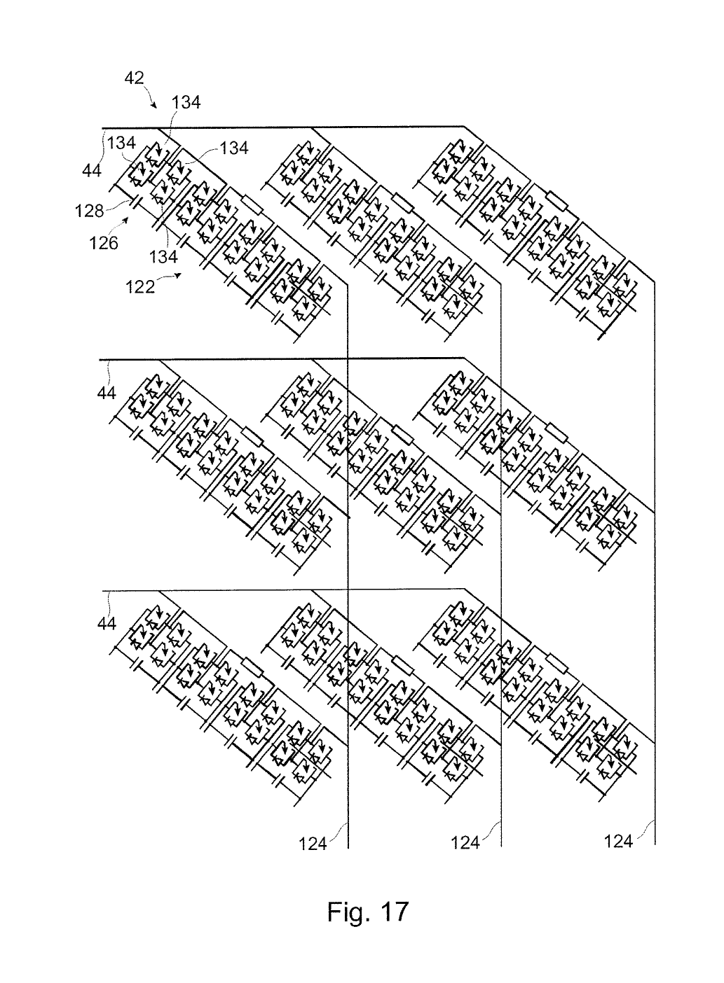

FIG. 17 shows a circuit diagram for a direct MMLC converter for a medium voltage system in accordance with an exemplary embodiment of the present disclosure. As shown in FIG. 17, a direct MMLC converter 42 includes nine multilevel branches 122 that are configured to directly convert the phase voltages from the phases 44 into the voltages at the phase outputs 124. Each branch includes a plurality of inverter cells 126 that are connected in series. Each inverter cell 126 includes an internal capacitor 128 that is connected in parallel to two pairs of semiconductor switches 134.

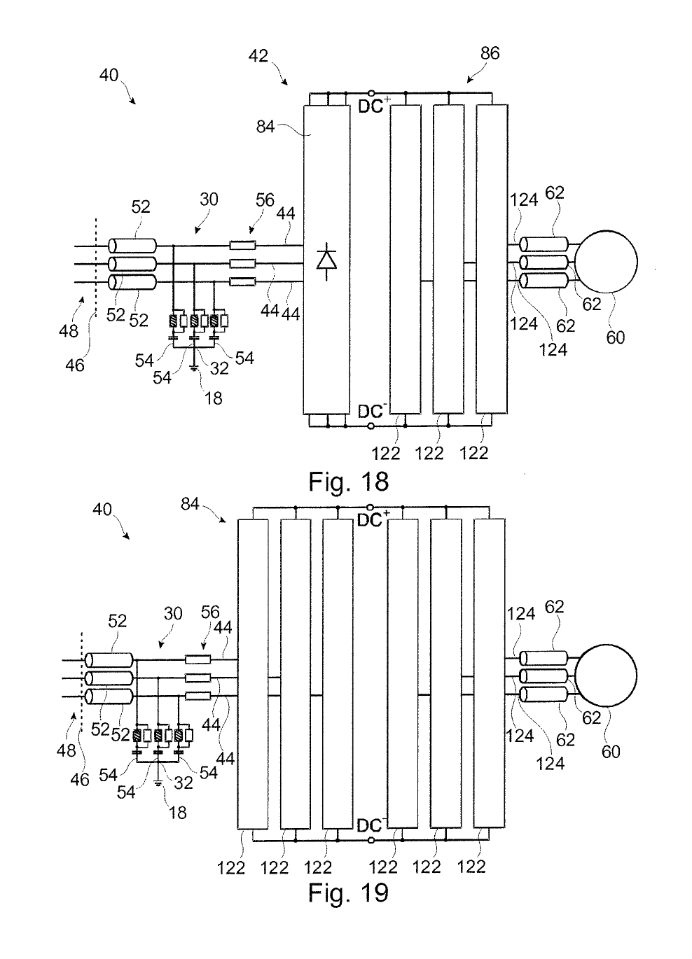

FIG. 18 shows a schematic diagram of a tenth medium voltage system in accordance with an exemplary embodiment of the present disclosure. As shown in FIG. 18, a medium voltage system 40 with an MMLC inverter 86 includes the exemplary features shown in FIG. 16. The converter 42 includes a passive diode rectifier 42 that is supplied by the phases 44 for generating a DC current that is supplied to the multilevel branches 122 of the inverter 126. The converter 42 of FIG. 18 is a two quadrant (2Q) converter 42.

FIG. 19 shows a schematic diagram of an eleventh medium voltage system in accordance with an exemplary embodiment of the present disclosure. As shown in FIG. 19, a medium voltage system 40 with an MMLC inverter 86 includes the exemplary features shown in FIG. 16. FIG. 19 is distinguishable from FIG. 18 in that the rectifier is also an MMLC inverter as shown in FIG. 16. Three further multilevel branches 122 are used for rectifying the current from the phases 44. The converter 42 of FIG. 18 is a four quadrant (4Q) converter 42.

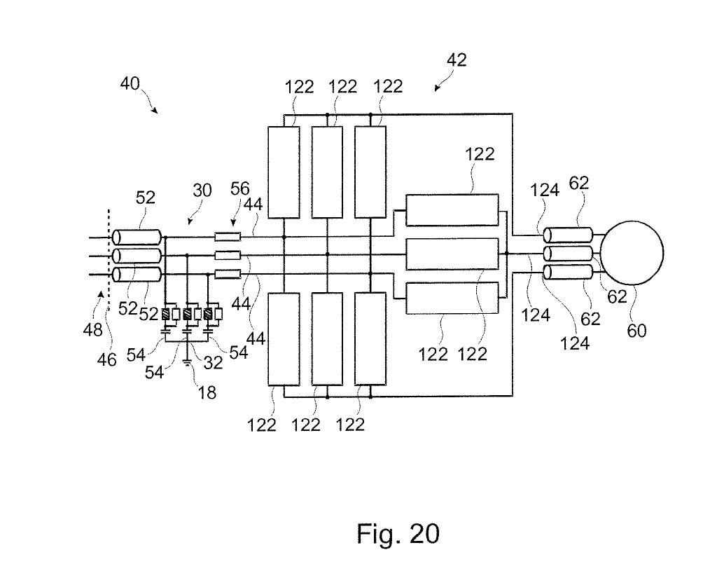

FIG. 20 shows a schematic diagram of a twelfth medium voltage system in accordance with an exemplary embodiment of the present disclosure. As shown in FIG. 20, a medium voltage system 40 with a direct MMLC inverter 86 includes the exemplary features shown in FIG. 17.

### Transformerless Medium Voltage Multilevel Systems

For the investigation and simulation of the transformerless medium voltage system 40, earthed on the grid side at the star point 32 of a common mode filter 30 with a capacitive filter network, a four quadrant, seven-level converter 42 has been selected.

The following table shows data of a system 40 and of a common mode filter 30 in accordance with an exemplary embodiment disclosed herein.

| | | |
|---|---|---|
| VLL | 3300 | [V] |
| IL | 200 | [A] |
| S | 1143 | [kVA] |
| fN | 50 | [Hz] |
| L_{f} | 2.4 | [mH] |
| C_{f} | 16.7 | [μF] |

As indicated in the table, a system voltage of 3300 V has been selected.

The grid side filter L_{f} has been designed with an 8% filter reactor and a filter capacitor C_{f} of 5% (see table IV).

To implement some additional current limiting impedance versus the grid side, the common mode filter 30 has been designed as a tuned filter. This can be of special interest in case of low impedance grounded medium voltage grids 48. Additionally, this measure can allow the robust active damping of the grid side resonance frequency and harmonic rejection in all conditions with a reasonably low switching frequency.

The following table shows data for a tuned filter 30.

| | | |
|---|---|---|
| C_{f} | 16.7 | [μf] |
| L_{f2} | 1.05 | [mH] |
| R_{f} | 4 | [Ohm] |

Depending on the number of voltage levels and length of the cable 62, a dv/dt filter 88 at the machine side can be specified. For the investigation disclosed herein, a small dv/dt filter 88 on the machine side has been implemented. In case of an MMLC converter 42, the phase or branch reactors can serve as main inductors for the dv/dt filter 88, which can request the addition of capacitive and resistive elements. In case of an ANPCML converter 42, separate inductive elements can be specified. The dv/dt filter 88 can increase the machine side capacitance to ground.

The following table shows data for an exemplary dv/dt filter 88.

| | | |
|---|---|---|
| Cf_dv/dt | 1 | [μF] |
| Lf_dv/dt | 25 | [uH] |
| R_dv/dt | 10 | [Ohm] |
| dv/dt | 130 | [V/us] |

The performance of the system 40 with the above selected data, for example in regards of common mode effects, is observed for low and high impedance grounded medium voltage grids 48.

Grid Side with Low Impedance Grounding

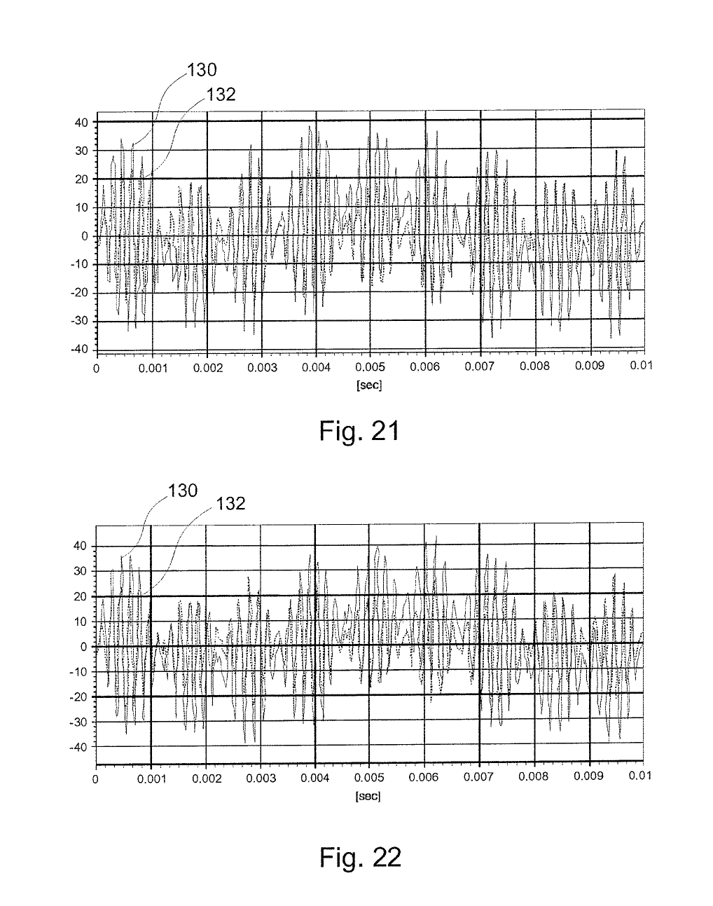

FIG. 21 shows a diagram with a common mode voltage at the grid side of a low impedance grounded system in accordance with an exemplary embodiment of the present disclosure. As shown in FIG. 21, a common mode voltage 130 and a common mode current 132 are compared at the grid side of a system 40. For the system 40, a low impedance grounding according to FIG. 1 with a neutral grounding resistor 16 has been selected. In the exemplary embodiment shown in FIG. 21, the current 132 and the voltage 130 are depicted over time.

In a low impedance grounded system 40, mainly the amplitude of the common mode current 132 has to be observed.

The current 132 will flow over the neutral grounding resistor 16 and is not allowed to thermally overload it. With the tuned filter 30, the following common mode current 132 and voltage 130 are observed at the grid side at the star point 32 of the filter 30 and in the neutral grounding resistor 80 of the grid 48:

u_CM_filter_star_point=16.8 V rms (0.9%)

i_CM_filter_star_point=11.0 A rms (5.5%)

i_CM_neutral_grounding=2.1 A rms (1.1%)

The common mode voltage 130 is low and below any limits given by standards. The common mode current 132 in the filter star point 32 looks quite high, but it should be taken into account, that in the exemplary embodiment 80% of this current is closing its loop over the cable 62, the dv/dt filter 88, and the capacitance of the machine 60. Only 20% of the common mode current 132 is actually flowing in the direction of the grid 48. This value of 20% is defined by the chosen value for the low impedance grounding resistor 80. The thermal loading of the low impedance grounding resistor should be acceptable.

Grid Side with High Impedance Grounding

FIG. 22 shows a diagram with a common mode voltage at the grid side of a high impedance grounded system in accordance with an exemplary embodiment of the present disclosure. As shown in FIG. 22, a common mode voltage 130 and a common mode current 132 are compared at the grid side of a system 40. For the system 40, a high impedance grounding according to FIG. 2 with a neutral grounding resistor 16′ has been selected.

In a high impedance grounded system, the amplitude of the common mode voltage 130 should be observed, which is present for other parallel connected loads at the point of common coupling 46 or the grid connection 46.

With the tuned filter 30, the following common mode currents and voltages at the grid side are observed at the star point 32 of the filter 30 and in the neutral ground resistor 16′ of the grid 48:

u_CM_filter_star_point=18 V rms (1%)

i_CM_filter_star_point=11.1 A rms (5.5%)

i_CM_neutral_grounding=0.04 A rms (0.02%)

The common mode current 132 in the filter star point 32 is closing its loop over the cable 62 and the capacitance of the machine 60. Only 0.02% of the common mode current 132 is flowing in the direction of the grid 48 (limited by the high impedance neutral grounding resistor 16′). Also in this case, the thermal load of the high impedance grounding resistor 16′ is acceptable.

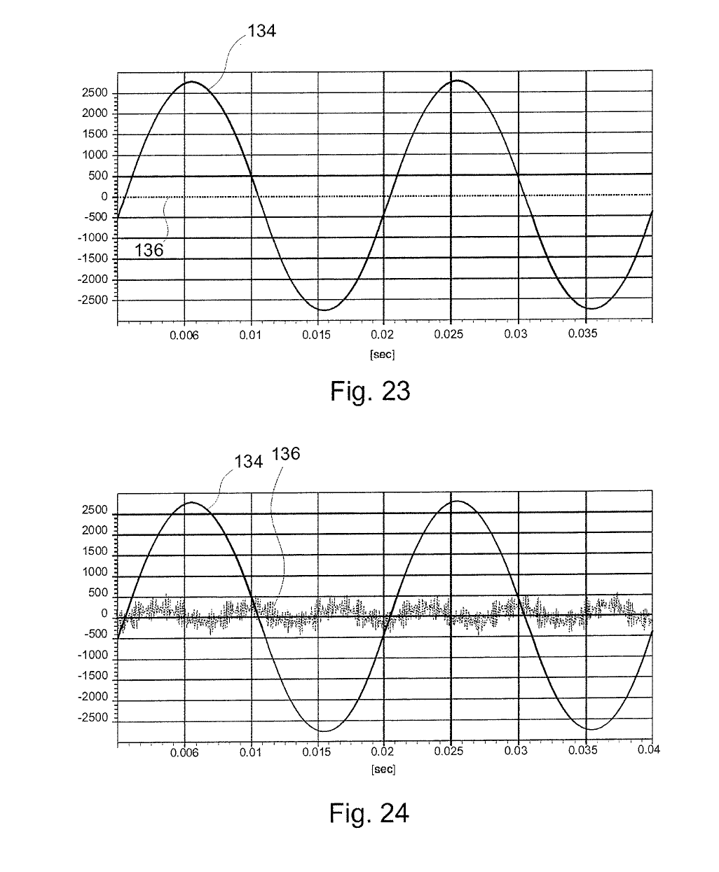

FIG. 23 shows a diagram with a common mode voltage at the PCC of a system in accordance with an exemplary embodiment of the present disclosure. As shown in FIG. 23, the phase voltage 134 and the common mode voltage 132 are compared. The common mode voltage 130 is low and below any limits given by standards.

### Machine Side

Since in low and high impedance grounded systems 40 we have a similar small common mode voltage 130 at the grid side, there is also no major difference between the two cases in regards of the common mode stresses on the electrical machine 60.

FIG. 24 shows a diagram with a common mode voltage at the machine star point of a system in accordance with an exemplary embodiment of the present disclosure. As shown in FIG. 24, the phase voltage 134 and the common mode voltage stress 136 are compared at the star point of the electrical machine 60.

FIG. 24 shows the resulting common voltage stress on the machine side for the investigated seven-level converter 42. The common mode voltage stress 136 related to the star point of the machine 60 is substantially higher than at the star point 32 of the tuned filter 30 at the grid side. This is intended by design and acceptable for any standard machine 60, as will be explained in the following.

The common mode peak voltage 136 in the stator winding is below 500 V. The low frequency and the high frequency common mode voltages of the total common mode voltage 136 appearing on the stator winding can be separated. According to an exemplary embodiment, low frequency common mode voltage movement of the stator winding should not be transferred to the rotor shaft and should therefore not create bearing currents. At low frequencies the capacitive coupling to the rotor should not be effective (e.g., influential). This is for example relevant for any third order harmonic of a 50 or 60 Hz supply grid 48. At higher frequencies we get an effective capacitive coupling to the rotor shaft, where for a 1 MVA machine a transfer ratio of 0.02 (or 1:50) is assumed.

According to FIG. 24, approximately 100 V are caused by the low frequency third harmonic component, which leaves us with a maximum of 400 V high frequency peak voltage. Taking into account a ratio of 1:50 to the induced peak voltage at the rotor shaft, a common mode peak voltage in the rotor shaft of less than 10 V is realized, which is within a safe design point in regards of potentially dangerous bearing currents. Even in case of the low output frequency operation of the modular multilevel converter 42, which generates additional low frequency common mode voltage stress on the machine side, a good behavior on machine side and grid side in regards of common mode voltage and currents, including bearing current effects, can be achieved.

According to exemplary embodiments disclosed herein, a cost-effective transformerless medium voltage system 40 can include multiple VSI based multilevel converter 42, such as an ANPCML converter 42 and an MMLC converter 42. Additional common mode impedances can be avoided without creating unacceptable common mode voltage 130 or current 132 on the grid side. Due to a small amount of high frequency common voltage 136 on the machine side, any dangerous bearing currents can be avoided.

While the disclosure has been illustrated and described in detail in the drawings and foregoing description, such illustration and description are to be considered illustrative or exemplary and not restrictive; the disclosure is not limited to the disclosed exemplary embodiments. Other variations to the disclosed exemplary embodiments can be understood and effected by those skilled in the art and practising the claimed disclosure, from a study of the drawings, the disclosure, and the appended claims. In the claims, the word “including” does not exclude other elements or steps, and the indefinite article “a” or “an” does not exclude a plurality. A single processor or controller or other unit can fulfil the functions of several items recited in the claims. The mere fact that certain measures are recited in mutually different dependent claims does not indicate that a combination of these measures cannot be used to advantage. Any reference signs in the claims should not be construed as limiting the scope.

Thus, it will be appreciated by those skilled in the art that the present invention can be embodied in other specific forms without departing from the spirit or essential characteristics thereof. The presently disclosed exemplary embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A medium voltage system, comprising:
a multilevel converter connected to a grid connection, wherein the multilevel converter is configured for converting a first multiphase current provided at the grid connection into a second current; and
a common mode filter, which, for each phase of the first current, includes a phase filter connected to the respective phase,
wherein each phase filter is connected to a common filter star point which is connected to ground, and includes an inductance and a capacitance connected in series, and a resistance connected in series with the capacitance such that the inductance and the resistor are connected in parallel, and
wherein the common mode filter includes an impedance between the common filter star point and the ground.

2. The medium voltage system of claim 1, comprising:
an electrical motor for receiving the second current.

3. The medium voltage system of claim 1, comprising:
an electrical generator for generating the second current.

4. The medium voltage system of claim 1, comprising:
a DC source for providing the second current.

5. The medium voltage system of claim 1, comprising:
a transformer for transforming the second current.

6. The medium voltage system of claim 1, wherein the first multiphase current has two or three phases.

7. The medium voltage system of claim 1, wherein the multilevel converter includes an ANPCML converter.

8. The medium voltage system of claim 1, wherein the multilevel converter includes an indirect MMLC converter.

9. The medium voltage system of claim 1, wherein the multilevel converter includes a direct MMLC converter.

10. The medium voltage system of one claim 1, wherein the common mode filter, for each phase, includes an inductance connected between the grid connection and the multilevel converter.

11. The medium voltage system of claim 10, comprising:
an electrical motor for receiving the second current.

12. The medium voltage system of claim 10, comprising:
an electrical generator for generating the second current.

13. The medium voltage system of claim 10, comprising:
a DC source for providing the second current.

14. The medium voltage system of claim 10, comprising:
a transformer for transforming the second current.

15. The medium voltage system of claim 10, wherein the first multiphase current has two or three phases.

16. The medium voltage system of claim 10, wherein a connection point of a phase filter to the respective phase is between the grid connection and the inductance that is between the grid connection and the multilevel converter.

17. The medium voltage system of claim 16, comprising:
an electrical motor for receiving the second current.

18. The medium voltage system of claim 16, comprising:
an electrical generator for generating the second current.

19. The medium voltage system of claim 18, comprising:
a DC source for providing the second current.

20. The medium voltage system of claim 18, comprising:
a transformer for transforming the second current.
